(19) United States
(12) Patent Application Publication
(10) Pub. No.: US 2023/0324075 A1
(43) Pub. Date: Oct. 12, 2023

(54) FRESH AIR INLET WITH VORTEX DEBRIS COLLECTION

(71) Applicant: Broan-NuTone LLC, Hartford, WI (US)

(72) Inventors: Ryan Revers, Hartford, WI (US); Richard R. Sinur, Hartford, WI (US); Bradley Mergener, Hartford, WI (US); Brent Lillesand, Hartford, WI (US)

(21) Appl. No.: 18/299,108

(22) Filed: Apr. 12, 2023

Related U.S. Application Data
(60) Provisional application No. 63/330,099, filed on Apr. 12, 2022.

(51) Int. Cl. F24F 13/08; F24F 8/183; B01D 45/06

(52) U.S. Cl. CPC F24F 13/085; B01D 45/06; F24F 8/183

(57) ABSTRACT

A air inlet for an air handling unit includes an intake grate that extends around a central axis and is configured to admit an airflow therethrough. The air inlet further includes an outlet duct arranged to lie along the central axis and positioned radially inward of the intake grate. The air inlet further includes a debris collection housing.

### PRIORITY CLAIM

This application claims priority under 35 U.S.C. § 119(e) to U.S. Provisional Application Ser. No. 63/330,099, filed Apr. 12, 2022, which is expressly incorporated by reference herein.

### BACKGROUND

The present disclosure relates to an air inlet, and particularly to an air inlet that covers a hole in a wall of a building. More particularly, the present disclosure relates to an air inlet that covers a hole in an exterior wall of a building.

### SUMMARY

According to the present disclosure, an air inlet is configured to cover an opening to a building leading to an air handling unit. The air inlet includes an intake grate that is configured to admit an airflow therethrough toward the opening in the building. The air inlet may further include an outlet duct arranged to lie inward of the intake grate. The air inlet may further include a debris collection housing configured to collect particles entrained in the airflow and retain the particles in a debris collection space defined, at least partially, by the debris collection housing and located upstream of the outlet duct as the airflow continues downstream through the outlet duct without the particles.

In illustrative embodiments, the intake grate and the outlet duct are both annular and extend circumferentially around a central axis. The intake grate may include a plurality of beams that are each generally parallel with the central axis and that define, at least partially, a plurality of openings therebetween.

In illustrative embodiments, the outlet duct includes a mount ring that extends around the central axis and an intake cylinder coupled to the mount ring and that extends into the debris collection space. The outlet duct may further include an airflow fillet coupled to both the mount ring and a radially outer surface of the intake cylinder directly downstream of the plurality of openings, the airfoil fillet having a concave surface that extends from the mount ring to the intake cylinder. The plurality of beams may extend between and interconnect a radially outer edge of the mount ring and the debris collection housing.

In illustrative embodiments, the debris collection housing is spaced apart radially outward from the intake cylinder and includes a first housing section coupled to the plurality of beams and a second, cone-shaped housing section coupled to the first housing section. The first housing section may be trapezoidal in shape to cause a distance between the first housing section and the intake cylinder to decrease as the first housing section extends away from the mount ring. The second housing section may terminate at a point that is arranged along the central axis.

In illustrative embodiments, the debris collection space has a first, relatively, high pressure area directly downstream of the intake grate and a second, relatively-low pressure area, lower than the first relatively-high pressure area, directly upstream of a distal end of the outlet duct. The second relatively-low pressure area is configured to collect particles entrained in the airflow and retain the particles in the second, relatively-low pressure area upstream of the outlet duct as the airflow continues downstream through the outlet duct without the particles.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of an air inlet, in accordance with the present disclosure;

FIG. 2 is a section view of the air inlet from FIG. 1 showing that the air inlet includes a debris collection space that removes debris from the air prior to the air entering an air handling unit;

FIG. 3 is an enlarged view similar to FIG. 2;

FIG. 4 is another perspective view of the air inlet of FIG. 1; and

FIG. 5 is another perspective view of the air inlet of FIG. 1.

### DETAILED DESCRIPTION

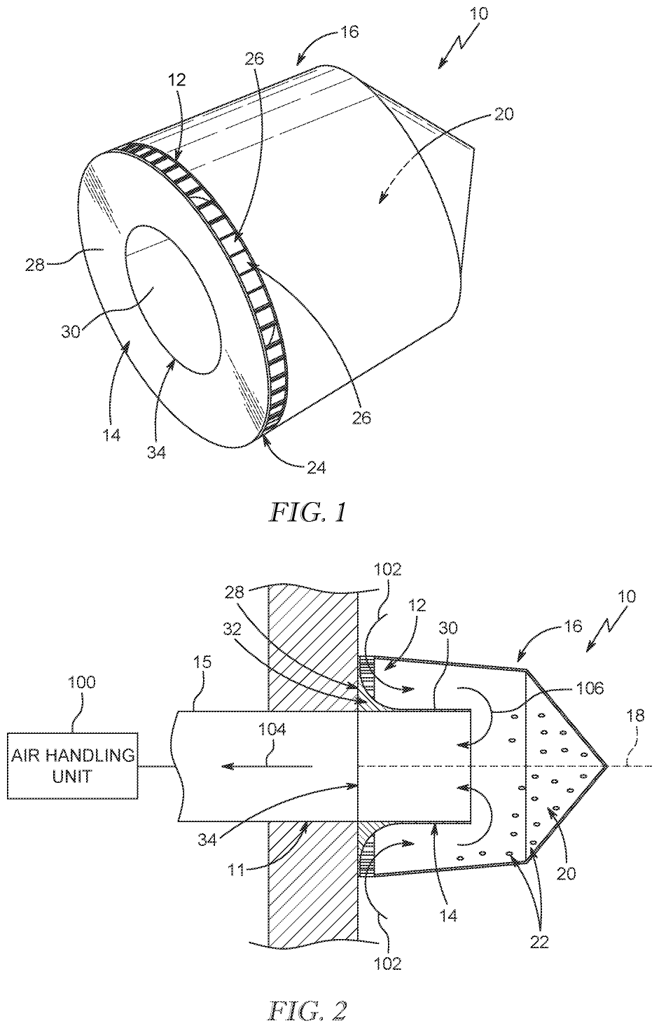

An air inlet 10 is configured to be coupled to an air handling unit 100 and is configured to receive and direct an airflow to the air handling unit 100 as shown in FIGS. 1 and 2. The air inlet 10 is illustratively embodied as an outdoor air inlet 10 for a fresh air system. The air inlet 10 is configured to be positioned in or adjacent to an opening 11 or hole in an exterior wall of a building as suggested in FIG. 2. The air handling unit 100 includes one or more fans that are configured to draw fresh air through the air inlet 10. The air inlet 10 covers the opening in the building to block relatively large objects, such as birds, insects, and other debris, from passing through the air inlet 10 and reaching the air handling unit 100 and/or entering the building.

The air inlet 10 includes an intake grate 12, an outlet duct 14, and a debris collection housing 16 positioned fluidly between the intake grate 12 and the outlet duct 14 as shown in FIGS. 1-3. The intake grate 12 extends around a central axis 18 and defines a plurality of intake openings 26 that are configured to admit an outdoor airflow 102 into the debris collection housing 16 as suggested in FIG. 2. The outlet duct 14 is arranged to lie along the central axis 18 and is positioned radially inward of the intake grate 12. The debris collection housing 16 is configured to collect particles 22 entrained in the airflow 102 and retain the particles 22 in a debris collection space 20 so that the particles are removed from the airflow 104 prior to reaching the air handling unit 100. As a result, an outlet airflow 104 (alternately referenced herein as “cleaned airflow”) exits the outlet duct 14 downstream into the opening 11 and may proceed to one or more ducts 15 leading to the air handling unit 100 or another device located in or around the building.

The debris collection space 20 is defined, at least partially, by the debris collection housing 16 and is located fluidly upstream of the outlet duct 14. Many particles 22 collect and stay within the debris collection space 20 due to changes in velocity/pressure of the airflow between the inlet airflow 102 and outlet airflow 104 within the air inlet 10. For example, the velocity of airflow changes from a first velocity entering the intake openings 26, to a second velocity in the debris collection space 20 defined in the debris collection housing 16. The second velocity is less than the first velocity. The airflow then changes to a third, relatively-high velocity in the outlet duct 14 downstream of the debris collection housing 16. The third velocity is greater than both the first and second velocities. The reduction in velocity in the debris collection space 20 causes the particles 22 to drop from the air flow prior to entering the outlet duct 14. The outlet airflow 104 may then continue downstream through the outlet duct 14 to the air handling unit 100 without particles 22 or with reduced particles 22 as a result of these changes in velocity through the air inlet 10.

The air inlet 10 also causes a rapid change in direction of the airflow 102 in relation to the change in velocities. For example, the depicted embodiment creates approximately a 180 degree turn as the airflow 102 travels from the debris collection space 20 to an interior of the outlet duct 14. Particles 22 may be removed from the airflow 102 by inertia as the airflow 102 makes the 180 degree turn and enters the interior of the outlet duct 14. In the illustrative embodiment, the airflow 102 rapidly changes from a higher velocity to a lower velocity at the same time the change in direction occurs and immediately prior to the highest velocity experienced by the airflow 102 so that the particles are left in the low velocity/pressure area in the debris collection space 20.

The intake grate 12 includes a plurality of beams 24 extending between the outlet duct 14 and the debris collection housing 16 as shown in FIGS. 1-3. The plurality of beams 24 extend generally parallel to the central axis 18 and are positioned circumferentially around the central axis 18 so that the intake grate 12 is configured to admit airflow 102 all the way around the central axis 18. The concepts described herein would also be facilitated by locating the beams 24 and intake openings 26 around less than the entirety of the central axis 18, such as only the lower half of the air inlet to avoid intake of rain or other falling objects from above. The plurality of beams 24 define the plurality of intake openings 26 circumferentially between each neighboring beam of the plurality of beams 24 such that each intake opening 26 opens in a radial direction relative to the central axis 18. Portions of the outlet duct 14 and the debris collection housing may also define the plurality of intake openings 26. The plurality of intake openings 26 are each generally square in shape when viewed in a radial direction relative to the central axis 18. In other embodiments, the plurality of intake openings 26 can have any shape depending on the orientation and structure of the plurality of beams 24 and the shape and structure of the outlet duct 14 and the debris collection housing 16.

The outlet duct 14 cooperates with the debris collection housing 16 to change the velocity of the airflow 102 entering the debris collection space 20 so that particles 22 are removed from discharged airflow 104 as shown in FIGS. 1 and 2. The outlet duct 14 includes a mount ring 28, an intake cylinder 30 coupled to the mount ring 28, and an airflow fillet 32 coupled to both the mount ring 28 and the intake cylinder 30. The mount ring 28 is configured to interface with an exterior wall of the building and surround the hole 11 formed in the building. The intake cylinder 30 is coupled to the mount ring 28 and extends away from the mount ring 28 into the debris collection space 20. The airflow fillet 32 is coupled between the mount ring 28 and the a radially outer surface of the intake cylinder 30 directly downstream of the plurality of intake openings 26 to guide the airflow 102 toward a distal end 31 of the intake cylinder 30 located within the debris collection space 20.

The mount ring 28 is a planar ring that may be attached to the exterior wall of a building or another structure as shown in FIG. 2. A radially inner edge 50 of the mount ring 28 defines an outlet opening 34 that is aligned with the hole 11 formed in the building. The outlet opening 34 may have a diameter that is the same or similar to the a diameter of the hole 11. Each of the plurality of beams 24 of the intake grate 12 are coupled to a radially outer edge 52 of the mount ring 28 spaced apart from the radially inner edge 50 defining the outlet opening 34 relative to central axis 18. The plurality of beams 24 extend between and interconnect the radially outer edge 52 of the mount ring 28 and the debris collection housing 16.

The intake cylinder 30 is coupled to the radially inner edge 50 of the mount ring 28 and extends circumferentially around the central axis 18. The intake cylinder 30 has a substantially constant diameter from the radially inner edge 50 of the mount ring 28 to the distal end 31 of the intake cylinder 30. In some embodiments, the total area of the plurality of openings 26 is greater than a cross-sectional area of the intake cylinder 30 taken perpendicular to the central axis to provide the differences in the first and third velocities described above. The plurality of openings 26 provides for a relatively low velocity to minimize formation of particle accumulation on the intake grate 12. Additionally, the intake grate 12 is exposed to an exterior of the inlet 10 to be cleaned by rainwater and/or a user-provided water flow from a hose, for example.

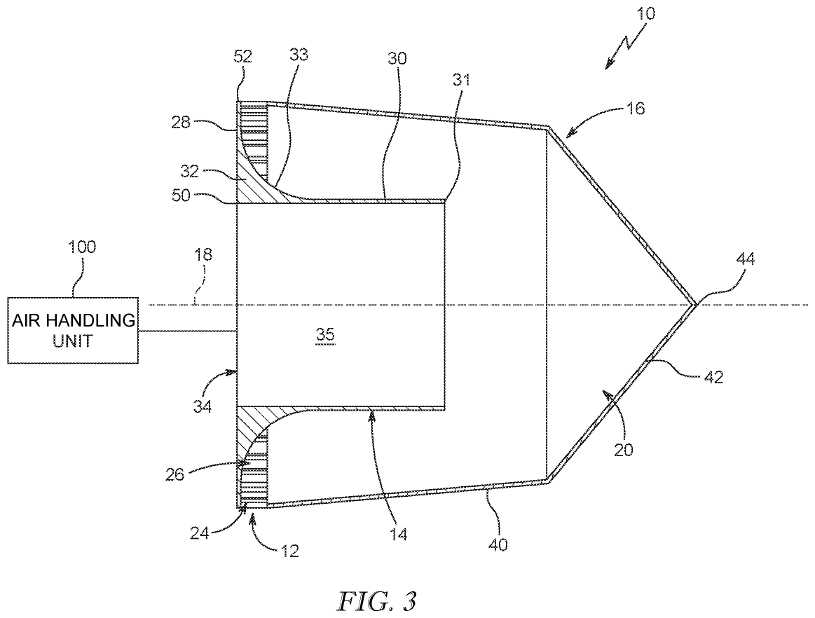

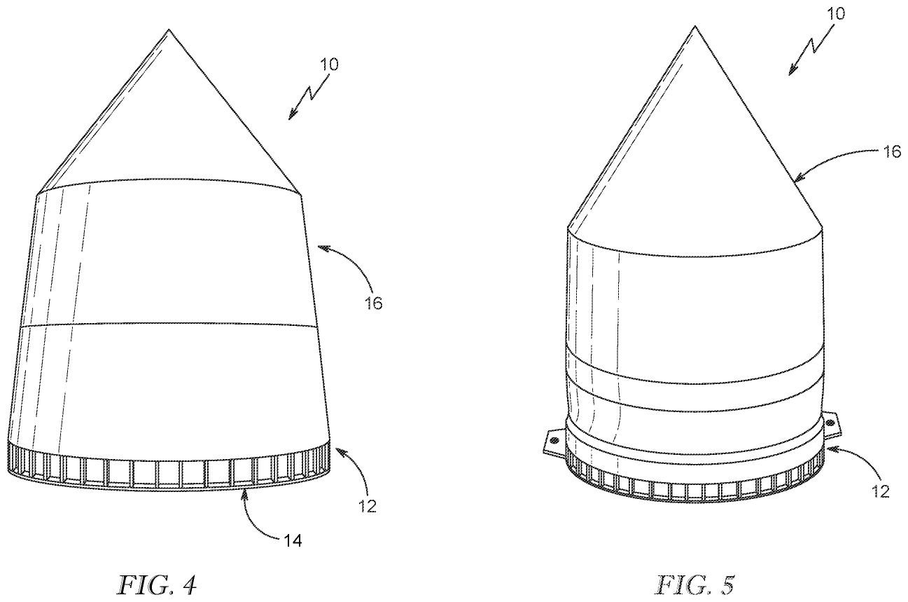

The airflow fillet 32 has an outer, concave surface 33 that extends between the mount ring 28 and the intake cylinder 30 as shown in FIG. 3. The concave surface 33 of the airflow fillet 32 may have a constant, arcuate curvature to direct the airflow 102 in a gradually curved manner along a generally 90 degree turn away from the mount ring 28 and the intake grate 12 and toward the debris collection space 20 as suggested in FIG. 2. Accordingly, the airflow 102 makes a first turn of about 90 degrees after entering through the plurality of openings 26 in the intake grate 12 and a second turn (106) of about 180 degrees from the debris collection space 20 into an interior 35 of the intake cylinder 30. The second turn creates a tortuous flow path for the airflow which causes removal of particles 22 entrained therein.

The debris collection housing 16 is spaced apart from the outlet duct 14 and includes a trapezoidal-shaped, first housing section 40 and a cone-shaped, second housing section 42 as shown in FIG. 3. The first housing section 40 extends between and interconnects the plurality of beams 24 of the intake grate 12 and the second housing section 42. The second housing section 42 is coupled to a distal end of the first housing section 40 and cooperates with the first housing section 40 to define the debris collection space 20. All or a portion of the debris-collection housing 16 may be separated from the intake grate 12 and the outlet duct 14 to empty debris collected within the debris collection space 20. In other embodiments, the debris-collection housing 16 may have an opening leading to a separate debris collection space (not shown) defined by a separate structure (also not shown). This separate structure may be separated from the debris-collection housing 16 to empty debris contained in the separate debris collection space.

The first housing section 40 is spaced apart from the intake cylinder 30 to provide a portion of the flowpath for the airflow 102 through the debris collection space 20 as shown in FIG. 3. A radial distance from the first housing section 40 to the intake cylinder 30 decreases as the first housing section 40 extends away from the intake grate 12 toward the second housing section. This decrease in distance is due to the trapezoidal shape of the first housing section 40 and causes the velocity of the airflow 102 to increase as the airflow 102 travels toward the distal end 31 of the intake cylinder. Stated differently, the first housing section 40 has a first diameter at a first end coupled to the intake grate 12 and a second diameter at a second end coupled to the second housing section 42. The second diameter is less than the first diameter such that the first housing section 40 gradually decreases in diameter from the first end to the second end. In other embodiments, the diameter of the first housing section 40 may remain constant or increase.

The intake cylinder 30 defines a length along the central axis 18 that is less than a length defined by the first section 40 of the debris collection housing 16 as shown in FIG. 3. Thus, the airflow 102 reaches the distal end 31 of the intake cylinder 30 prior to reaching the second housing section 42. In some embodiments, the first housing section 40 may terminate at substantially the same location along the central axis 18 as the distal end 31 of the intake cylinder 30.

After passing the distal end 31 of the intake cylinder 30, a distance from the distal end 31 to the second housing section 42 increase as the second housing section 42 extends away from the first housing section 40 as shown in FIG. 3. This increase in distance causes the velocity of the airflow 102 to decrease. Because the particles have a greater mass than the air, some or all of the particles 22 continue traveling toward a point 44 of the second housing section 42 due to inertia while the air makes the second turn and flows through the interior 35 of the intake cylinder 30 without the particles 22.

The air inlet 10 creates a large area of low pressure in the top of the cone (section 42) which allows debris to be ejected from the airflow path and get captured in the low-pressure area. The air inlet 10 may provide air filtering for an air handling unit 100. The air inlet may be a unitary component or made from multiple pieces that are assembled together. The air inlet 10 can be formed with various manufacturing additives (molded in or coated) to decrease surface friction of the surfaces of the air inlet 10 and block debris from adhering to the surfaces. These additives may include: anti-static (Cationic antistatic additives), Teflon coatings (i.e. PTFE—Polytetrafluoroethylene), silicone coatings, ceramic coatings (Sol-gel), etc. Although the air inlet 10 is depicted as having a generally circular cross section with central axis 18, it should be appreciated that the air inlet 10 may have any cross sectional shape such as a square, rectangle, hexagon, etc. The intake grate 12 may be located along all sides of the air inlet 10 or along only one or more of the sides.

The air inlet 10 is configured to provide a method of removing particles from the outdoor airflow 102. The method includes mounting the air inlet 10 to the building to cover the opening 11. When activated, the air handling unit 100 includes a fan that draws air through the intake grate 12 of the air inlet 10 and, after being cleaned, through the opening 11. The particles 22 are captured and retained in the debris collection space 20 prior to the air reaching the outlet duct 14 so that the particles are removed from the air 102.

The method further includes directing the air 102 through a serpentine flowpath defined by the air inlet to cause the particles to be removed from the airflow 102. The airflow 102 travels first through the intake grate 12 at a location spaced a first distance from the opening 11 in the building. Then, the airflow 102 makes a 90 degree turn and travels away from the opening 11 in the building toward a distal end 31 of the outlet duct 14. Then the airflow 102 makes a 180 degree turn and enters into the outlet duct 14 at the distal end 31 of the outlet duct 14. This serpentine flowpath causes the particles to be ejected from the airflow 102 into the debris collection space 20 by inertial forces.

The method also includes changing a velocity of the airflow 102 in the debris collection space 20 to help remove the particles 22. First, the method includes increasing a velocity of the airflow 102 at the intake grate 12. Then, the method includes decreasing the velocity of the airflow 102 radially between the outlet duct 14 and the first section 40 of the debris collection housing 16. Then, the method again includes increasing the velocity of the airflow 102 as the airflow 102 travels away from the intake grate 12 toward the distal end 31 of the outlet duct 14. Finally, the method again includes decreasing the velocity of the airflow 102 once the airflow passes the distal end 31 of the outlet duct 14. This change in velocity of the airflow 102 and/or the 180 degree turn causes the particles to be ejected from the airflow 102 in the second section 42 of the debris collection housing 16 downstream of the first section 40 of the debris collection housing.

1. An air inlet for an air handling unit, the air inlet comprising
an intake grate that is configured to admit an airflow therethrough,
an outlet duct arranged to lie inward of the intake grate, and
a debris collection housing configured to collect particles entrained in the airflow and retain the particles in a debris collection space defined, at least partially, by the debris collection housing and located upstream of the outlet duct as the airflow continues downstream through the outlet duct without the particles.

2. The air inlet of claim 1, wherein the intake grate and the outlet duct are both annular and extend circumferentially around a central axis.

3. The air inlet of claim 2, wherein the intake grate includes a plurality of beams that are each generally parallel with the central axis and that define, at least partially, a plurality of openings therebetween.

4. The air inlet of claim 3, wherein the outlet duct includes a mount ring that extends around the central axis and an intake cylinder coupled to the mount ring and that extends into the debris collection space.

5. The air inlet of claim 4, wherein the outlet duct further includes an airflow fillet coupled to both the mount ring and a radially outer surface of the intake cylinder directly downstream of the plurality of openings, the airfoil fillet having a concave surface that extends from the mount ring to the intake cylinder.

6. The air inlet of claim 4, wherein the plurality of beams extend between and interconnect a radially outer edge of the mount ring and the debris collection housing.

7. The air inlet of claim 4, wherein the debris collection housing is spaced apart radially outward from the intake cylinder and includes a first housing section coupled to the plurality of beams and a second, cone-shaped housing section coupled to the first housing section.

8. The air inlet of claim 7, wherein the first housing section is trapezoidal in shape to cause a distance between the first housing section and the intake cylinder to decrease as the first housing section extends away from the mount ring.

9. The air inlet of claim 7, wherein the second housing section terminates at a point that is arranged along the central axis.

10. The air inlet of claim 1, wherein at least the intake grate includes at least one of an anti-static material, Polytetrafluoroethylene, silicone, and a ceramic coating.

11. An air inlet for an air handling unit, the air inlet comprising
an intake grate that is configured to admit an airflow therethrough,
an outlet duct arranged to, at least partially, lie downstream of the intake grate, and
a debris collection housing configured to provide a debris collection space having a first, relatively, high pressure area directly downstream of the intake grate and a second, relatively-low pressure area, lower than the first relatively-high pressure area, directly upstream of a distal end of the outlet duct to collect particles entrained in the airflow and retain the particles in the second, relatively-low pressure area upstream of the outlet duct as the airflow continues downstream through the outlet duct without the particles.

12. The air inlet of claim 11, wherein the intake grate and the outlet duct are both annular and extend circumferentially around a central axis, and wherein the intake grate includes a plurality of beams that are each generally parallel with the central axis and that define, at least partially, a plurality of openings therebetween.

13. The air inlet of claim 12, wherein the outlet duct includes a mount ring that extends around the central axis, an intake cylinder coupled to the mount ring and that extends into the debris collection space, and an airflow fillet coupled to both the mount ring and a radially outer surface of the intake cylinder directly downstream of the plurality of openings, the airfoil fillet having a concave surface that extends from the mount ring to the intake cylinder.

14. The air inlet of claim 13, wherein the plurality of beams extend between and interconnect a radially outer edge of the mount ring and the debris collection housing, and the debris collection housing is spaced apart radially outward from the intake cylinder and includes a first housing section coupled to the plurality of beams and a second, cone-shaped housing section coupled to the first housing section.

15. The air inlet of claim 14, wherein the first housing section is trapezoidal in shape to cause a distance between the first housing section and the intake cylinder to decrease as the first housing section extends away from the mount ring.

16. A method of removing particles from an airflow, the method comprising
providing an air inlet that covers an opening into a building;
drawing air through the air inlet and the opening; the air inlet including an intake grate that is configured to admit the airflow therethrough, an outlet duct arranged to, at least partially, lie inward of the intake grate, and a debris collection housing configured to provide a debris collection space, and
capturing and retaining the particles in the debris collection space prior to the air reaching the outlet duct,
wherein the airflow travels, first, through the intake grate at a location spaced a first distance from the opening in the building, then the airflow makes a 90 degree turn and travels away from the opening in the building toward a distal end of the outlet duct, and then the airflow makes a 180 degree turn and enters into the outlet duct at the distal end of the outlet duct.

17. The method of claim 16, further comprising, first, increasing a velocity of the air at the intake grate, then decreasing the velocity of the air radially between the outlet duct and a first section of the debris collection housing, then decreasing the velocity of the air in a second section of the debris collection housing downstream of the first section of the debris collection housing.

18. The method of claim 17, further comprising increasing the velocity of the air after decreasing the velocity of the air between the outlet duct and a first section of the debris collection housing.

19. The method of claim 16, wherein the intake grate and the outlet duct are both annular and extend circumferentially around a central axis, and wherein the intake grate includes a plurality of beams that are each generally parallel with the central axis and that define, at least partially, a plurality of openings therebetween.

20. The method of claim 19, wherein the outlet duct includes a mount ring that extends around the central axis, an intake cylinder coupled to the mount ring and that extends into the debris collection space, and an airflow fillet coupled to both the mount ring and a radially outer surface of the intake cylinder directly downstream of the plurality of openings, the airfoil fillet having a concave surface that extends from the mount ring to the intake cylinder.
